(19) United States
(12) Patent Application Publication
(10) Pub. No.: US 2015/0274982 A1
(43) Pub. Date: Oct. 1, 2015

(54) TWO STEP DYEING PROCESS FOR PROTECTIVE YARNS AND TEXTILES MADE FROM HIGH TENACITY FIBERS

(71) Applicant: WARWICK MILLS, INC., New Ipswich, NH (US)

(72) Inventor: Charles A. Howland, Temple, NH (US)

(73) Assignee: WARWICK MILLS, INC., New Ipswich, NH (US)

(21) Appl. No.: 14/203,830

(22) Filed: Mar. 11, 2014

Related U.S. Application Data
(60) Provisional application No. 61/779,264, filed on Mar. 13, 2013.

(51) Int. Cl. C09D 5/00; D06P 3/52; D06P 5/00; D06P 3/24

(52) U.S. Cl. CPC C09D 5/002; D06P 3/24; D06P 3/52; D06P 5/001

(57) ABSTRACT

The present invention is a method for coloring knit, woven, or non-woven protective textiles made from yarns containing at least 20% synthetic high tenacity fibers, such as para-aramid or liquid crystal polyester (“LCP”), and for package-dyeing and skein-dyeing of such yarns. In embodiments, the textile is scoured to remove any impurities. A base coating of an adhesion promoting primer is then applied, which is typically a polymer or elastomer. The textile is typically immersed at zero tension in the primer liquor for an extended period. Afterward, the primer is dried and then cured at an elevated temperature to cross-link the primer and provide wash-fastness. A dye or printing ink of substantially any desired color and intensity is then applied. The protective yarns can include staple fibers and/or continuous filament fibers. The invention is further applicable to drum coating, jig processing, dye beck and other dying and coating processes.

### RELATED APPLICATIONS

This application claims the benefit of U.S. Provisional Application No. 61/779,264, filed Mar. 13, 2013, which is herein incorporated by reference in its entirety for all purposes.

### FIELD OF THE INVENTION

The invention relates to textiles manufactured from high tenacity fibers such as para-aramid and other liquid crystal polymers, and more particularly, to methods for dyeing such textiles.

### BACKGROUND OF THE INVENTION

The variety and types of threats encountered by soldiers in combat, as well as by law enforcement officers and others, continues to expand. Also, it can be difficult to be certain when circumstances are “safe,” and when combat may be imminent.

Soldiers have long worn protective armor to offset many kinds of ballistic and fragmentary threats. Such armor typically is worn over the user's clothing as one or more add-on pieces supported by a separate non-protective textile carrier, with protective elements often being inserted into a non-protective textile slip cover of the textile carrier. Typically, such body armor includes thick, rigid panels, and is too bulky, heavy, and inflexible to be worn at all times. Moisture transport can also be quite low for such armor, making the armor uncomfortable to wear for extended periods. And the added heat retention due to wearing the body armor over conventional clothing can result in significant heat stress for the user. As a result, conventional body armor is not always worn when it is needed.

A significant increase in protection could be realized if the clothing worn by a soldier or other user could be protective in and of itself, so that less or possibly no additional layers of protection were needed. This would reduce the added heat and weight burdens of protective body armor, and would increase the likelihood that the protection would be in place when needed, even under circumstances where a threat was unanticipated.

Protective textiles can be produced by including protective fibers such as para-aramid and/or another liquid crystal polymer in the yarns of a fabric. However, such protective textiles have not previously been used to fabricate protective garments that would replace conventional clothing. Instead, protective fabrics have been generally relegated to armor configurations that are worn over conventional clothing and are covered by slip covers or other outer layers of non-protective textile. Note that the terms “protective fibers” and “high tenacity fibers” are used herein to refer to fibers have an average tenacity of at least 12 gpd, unless otherwise required by the context.

One problem that has prevented the practical use of clothing made from protective fabric is the near-impossibility of dyeing such fabrics, and/or printing patterns onto such fabrics. Textile dyeing, which dates back to the Neolithic period, is the process of adding color to textile products, either fiber, yarn, or fabrics. Typically, dyeing is performed by submerging the textile in a solution of pigments, dyes and chemicals. The process creates a chemical bonding of the dye or pigment molecules to the fiber molecules. This textile dyeing process is readily applicable to cotton, polyester, nylon, silk, wool and acrylic fibers.

However, synthetic, high tenacity fibers, such as para-aramid and other liquid crystal polyesters, typically lack the molecular sites that are necessary for proper attachment of ink or dye molecules. As a result, typical prior art fabrics constructed from these fibers are not readily dyed, and do not typically yield fabrics, upon dyeing, that have an essentially uniform color density. The problem is even greater when it is desired to print a pattern, such as a camouflage pattern, onto a fabric made from high tenacity fibers. This is because printing requires much better color acceptance, as compared to a dyeing process in which a textile can be submerged in the dyeing liquor for an extended period and thoroughly saturated with dye.

One approach is to add color to the raw un-spun polymer and then spin the protective fiber as a colorized fiber known as dope dyed filament. However, such pre-fiber-formation dyeing can be expensive, lacks flexibility, is not suitable for pattern dyeing or printing, and is typically only useful for colors that are darker than the base color of the high tenacity material forming the high tenacity fibers (e.g., para-aramid and liquid crystalline polyester have a base color of gold/yellow).

Another approach is to form a protective textile using yarns that are intimate blends of protective and conventional fiber types. However, this approach adds weight to the fabric without adding protection. Also, the resulting textile can only accept dyes or inks onto its conventional fibers, which limits the range of color intensities that can be achieved. In addition, this approach does not mask the base color of the protective fibers, which further limits the range of colors that can be achieved, especially if a color is desired that is lighter than the base color of the protective fibers.

What is needed, therefore, is a method for applying a dye color or printed pattern of substantially any desired color or color combination and any desired color intensity to protective textiles that include at least 20% high tenacity fibers.

### SUMMARY OF THE INVENTION

The present invention is a method for dyeing knit, woven, or non-woven textiles made from yarns containing at least 20% synthetic high tenacity fibers, such as para-aramid, liquid crystal polyester (“LCP”), and for package-dyeing and skein-dyeing of such yarns. Embodiments of the present invention are applicable to yarns comprising staple fibers, continuous filament fibers, and any combination thereof, as well as blends, plies, and other mixtures of fibers. The invention is further applicable to drum coating, jig processing, dye beck and other dying pieces, rope, and open width dyeing, pigmentation, and coating processes.

Durable attachment of coloring molecules to the high tenacity fibers is achieved by first applying a base coating of an adhesion promoting primer to the fabric, followed by layers of pigment, or substantive dyes.

One general aspect of the present invention is a colorized yarn or textile that includes a yarn containing at least 20% protective fibers, or a textile constructed from yarns containing at least 20% protective fibers, where protective fibers are defined as fibers having a tenacity of at least 12 gpd, a primer layer coating substantially all of the fibers, the primer layer being cross-linked sufficiently to render it insoluble under garment-washing conditions, the primer layer including molecular binding sites that are compatible for attachment of ink or dye molecules thereto, and a coloration layer including at least one of a substantive dye and pigment, the coloration layer being attached to the primer layer by a polymeric binding layer.

In embodiments, the protective fibers are liquid crystal polymer fibers. In some embodiments, the protective fibers are para-aramid. In other embodiments, the protective fibers are liquid crystal polyester fibers. In certain embodiments, the primer includes a polymer. And in various embodiments the primer includes an elastomer.

In various embodiments the primer includes a water-born or solvent-born acrylate or acrylate co-polymer. In some embodiments the primer includes a water-born or solvent-born aliphatic, polyether, polycarbonate, or caprolactone urethane or a co-polymer thereof.

In other embodiments, the primer includes a water-born or solvent-born isocyanate copolymer. In certain embodiments, the primer includes a water-born or solvent-born chloroprene or chloroprene coelastomer. And in various embodiments the primer includes a water-born or solvent-born epoxide or epoxide copolymer.

In embodiments, the primer includes a water-born melamine or melamine copolymer. In some embodiments, the primer includes a water-born urea or urea copolymer. In other embodiments, the primer layer includes a water-born pigment.

In certain embodiments the primer layer includes a solvent-born pigment. And in various embodiments substantially all of the fibers are protective fibers.

In some embodiments the primer layer has a surface energy of greater than 35 mJ/m2. In other embodiments the molecular binding sites of the primer layer include hydroxyl sites.

In various embodiments the molecular binding sites of the primer layer include hydrogen bonding sites. In certain embodiments the molecular binding sites of the primer layer include nitrile sites. In some embodiments, the polymeric binding layer coats substantially all of the primer layer. In other embodiments the polymeric binding layer includes an acrylate or a urethane.

Embodiments further include an antimicrobial layer coating the pigment-binding layer or substantive dye coating layer. In some embodiments the substantive dye is direct, basic, cationic, or reactive. And in other embodiments, the coloration layer includes an inorganic pigment.

Another general aspect of the present invention is a method for coloring a protective yarn or textile. The method includes providing a protective yarn containing at least 20% protective fibers, or a protective textile constructed from yarns containing at least 20% protective fibers, where protective fibers are defined as fibers having a tenacity of at least 12 gpd, applying a primer layer to the protective yarn or protective textile so that the primer layer coats substantially all of the fibers, the primer layer including molecular binding sites that are compatible for attachment of ink or dye molecules thereto, drying the protective yarn or textile so as to remove any excess water or solvent, heating the protective yarn or textile to a temperature sufficient to cause the primer layer to cross-link sufficiently to render it insoluble under garment-washing conditions, and applying a substantive dye or pigment to the primer layer, so that the dye or pigment is attached to the molecular binding sites of the primer layer by a polymeric binding layer.

In embodiments, the primer layer is applied in a dye beck, dye jig, piece dye, or jet dye apparatus. In some embodiments the protective yarn or textile is under substantially zero tension during application of the primer layer. In other embodiments substantially all of the fibers are protective fibers.

In various embodiments the primer layer has a surface energy of greater than 35 mJ/m2.

Certain embodiments further include coating substantially all of the primer layer with a pigment-binding layer or substantive dye coating layer. In some of these embodiments the pigment-binding layer includes an acrylate or a urethane. Other of these embodiments further include coating the pigment-binding layer or substantive dye coating layer with an antimicrobial layer. In still other of these embodiments the primer includes a water-born or solvent-born acrylate or acrylate co-polymer. In yet other of these embodiments the primer includes a water-born or solvent-born aliphatic, polyether, polycarbonate, or caprolactone urethane or a co-polymer thereof. And in certain of these embodiments the primer includes a water-born or solvent-born isocyanate copolymer.

In embodiments, n the primer includes a water-born or solvent-born chloroprene or chloroprene coelastomer. In some embodiments the primer includes a water-born or solvent-born epoxide or epoxide copolymer. In other embodiments the primer includes a water-born melamine or melamine copolymer. And in various embodiments the primer includes a water-born urea or urea copolymer.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is simplified side view of a polymer fiber to which an embodiment of the present invention has been applied, showing the layers that are applied to the base fiber;

FIG. 2 is an SEM image showing low-angle wetting of a urethane primer onto para-aramid fiber;

FIG. 3 is an SEM image showing low-angle wetting of an acrylate primer onto LCP fiber;

FIG. 4 is an SEM image of a urethane primer applied to LCP fiber;

FIG. 5 is an SEM image similar to FIG. 4 but at enhanced resolution;

FIG. 6 is an SEM image similar to FIG. 5, but with a higher coating pick-up; and

FIG. 7 is a block diagram illustrating the steps of an embodiment of the present invention.

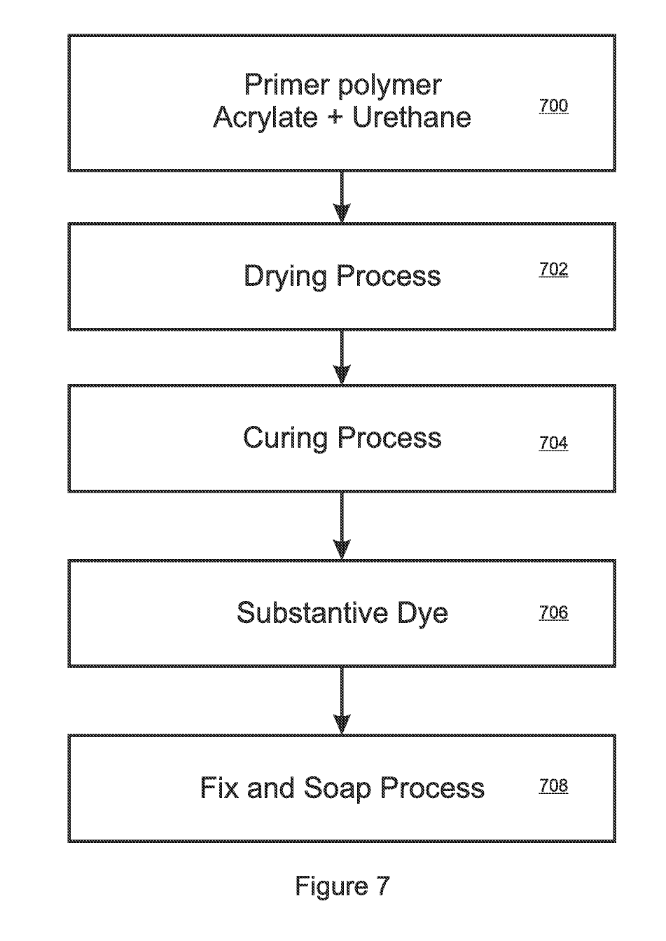

### DETAILED DESCRIPTION

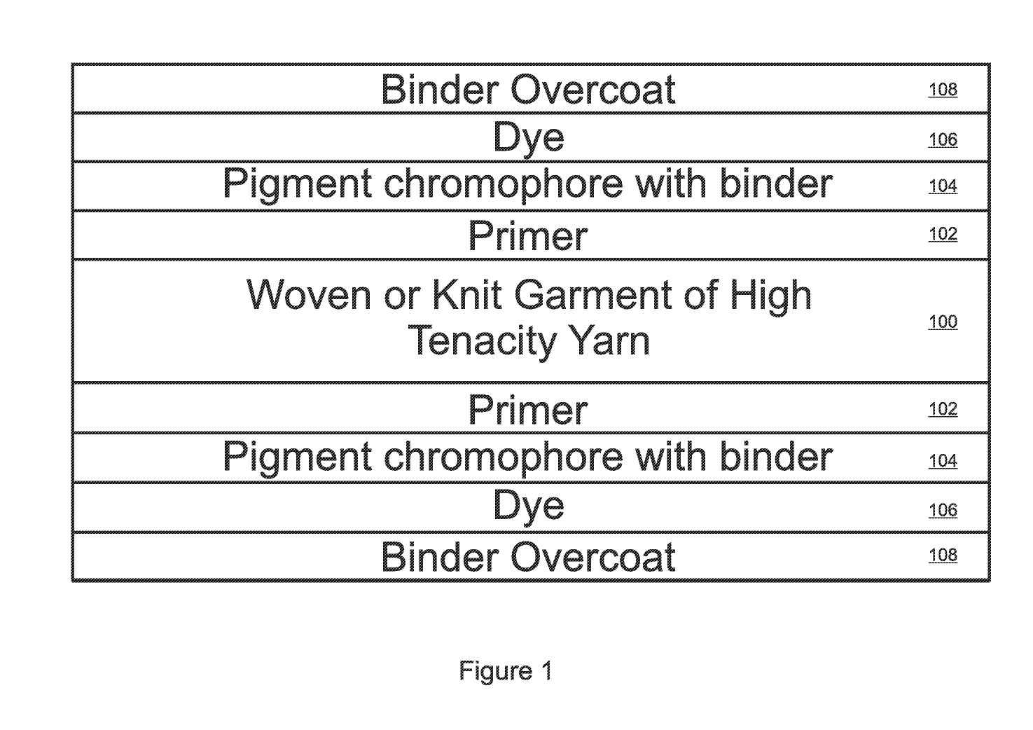

The present invention is a method for dyeing knit, woven, or non-woven textiles made from yarns containing at least 20% synthetic, high tenacity fibers, by first applying a base coating of an adhesion promoting primer to the textile, curing the primer, and then applying layers of pigment or substantive dyes to the primed fibers. FIG. 1 illustrates the layers that are applied in embodiments of the present invention. After the primer 102 is applied to the high tenacity yarn or textile 100, in embodiments a chromophore with binder is applied 104, followed by a dye 106, and lastly with a binder overcoat 108.

### Primers

The use of a primer on the surface of a highly crystalline fiber provides an opportunity to modify the surface characteristics of the fiber so that it can be more effectively dyed and/or pigmented with commercial coloration systems. The formulation of the primer varies according to the embodiment, with some embodiments using a polymer or an elastomer as a primer. The guideline for primer formulation is that the primer must have a good surface energy match with the fiber surface. In some embodiments, the sessile drop angle is less than 15 degrees. It is also important that the acid-to-base ratio of the primer to fiber is not excessive.

In embodiments, the primary contribution to the adhesive energy of the primer is the diffusive components of the surface energy. Using the Van Oss total surface energy equations, the diffusive components can be separated from the total surface energy.

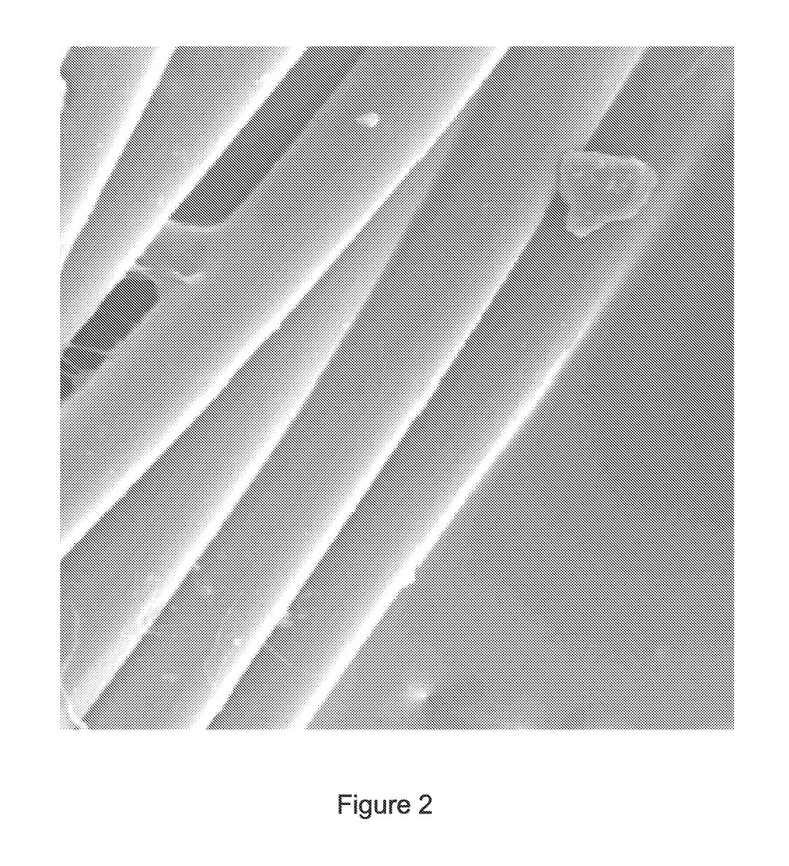

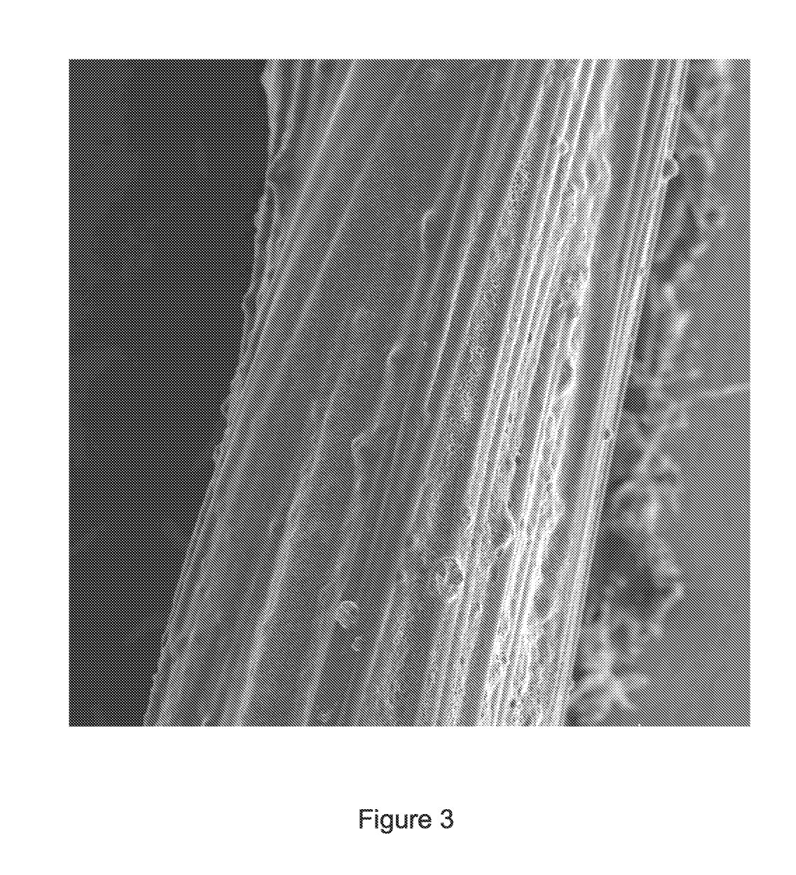

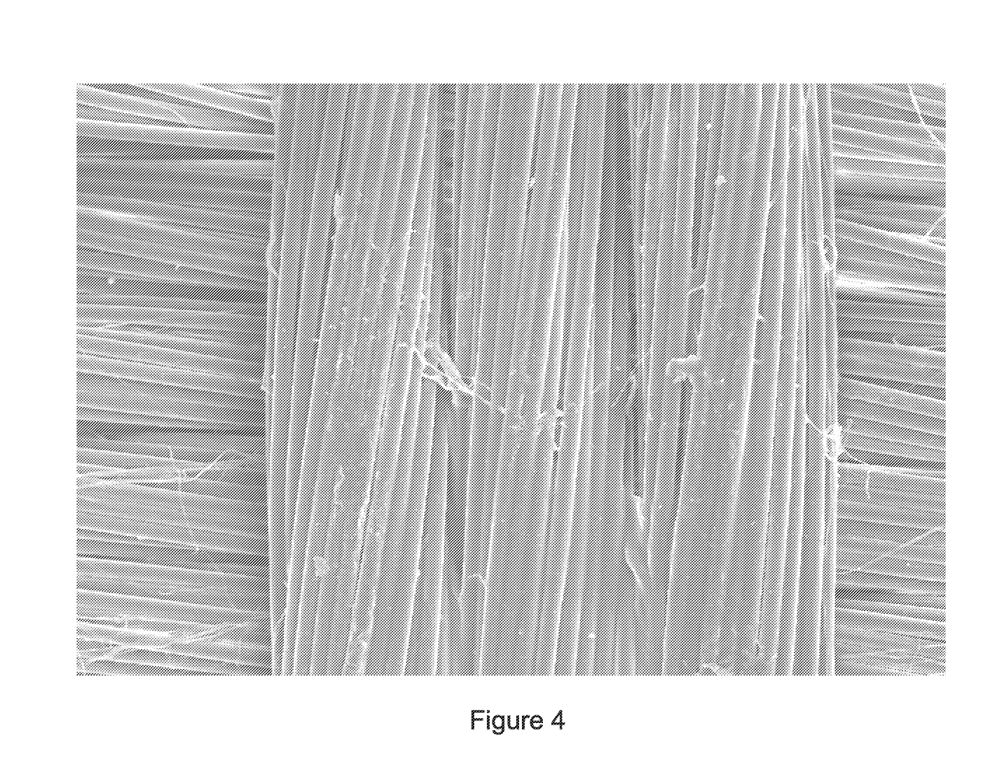

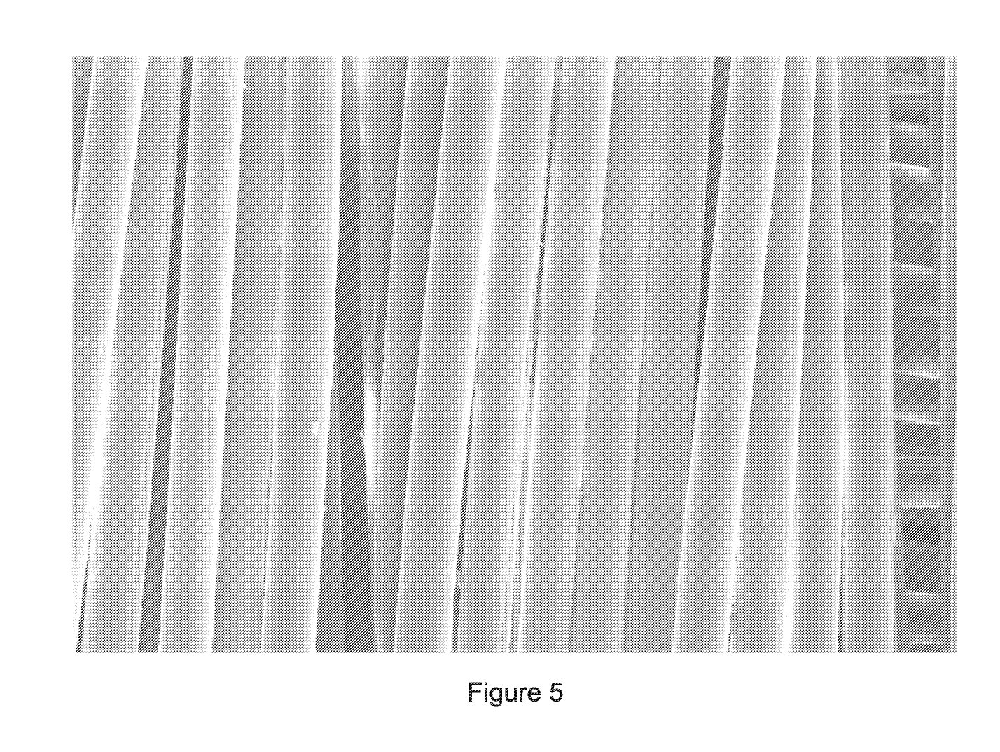

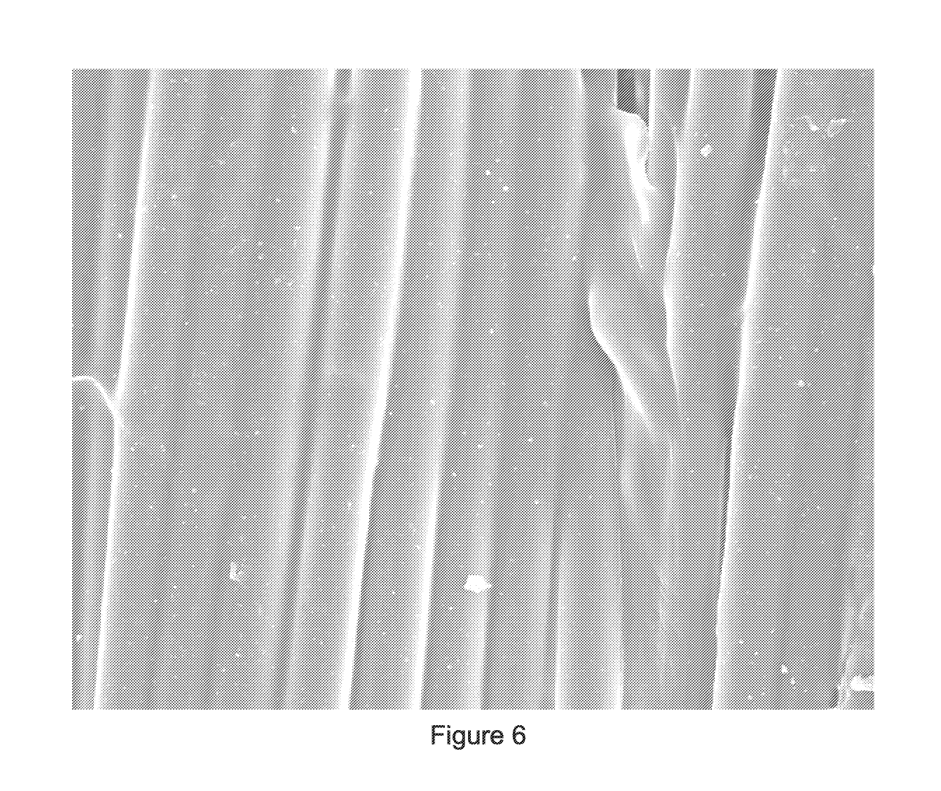

In various embodiments, the curing step of the primer application is performed at a high enough temperature to ensure that there is good fluid flow and wetting of the primer onto the fiber surface. This condition can be seen in high depth-of-field scanning electron micrographs. In certain embodiments, the primer selection and curing process provide low wetting angles between the fiber and the primer after curing. An example of low-angle wetting of a urethane primer onto para-aramid fiber is shown in FIG. 2. An example of low-angle wetting of an acrylate primer onto LCP fiber is shown in FIG. 3. FIG. 4 is an SEM image of a urethane primer applied to LCP fiber, FIG. 5 is an SEM image similar to FIG. 4 but at enhanced resolution, and FIG. 6 is an SEM image similar to FIG. 5, but with a higher coating pick-up.

In embodiments, the primer is cross-linked during the curing step. The degree of crosslinking is sufficient to provide good wash-fastness to the primer, but is not so extensive as to cause undue stiffening of the fabric that degrades its softness. In particular, primer systems that have good hydrolysis and wash-fastness can retain some thermoplastic characteristics and still be effective. In practice, the need to preserve the soft hand of the textile sets an upper bound on the dry pick-up of the primer system. In embodiments, 5% dry pickup is adequate to provide a basis for the subsequent pigmentation and dying steps, and in many embodiments primer pickup in the range of 0.5 to 2.5% is adequate.

The following is a list of primers that are used in various embodiments of the present invention:
water-born or solvent-born acrylate or acrylate copolymers
water-born or solvent-born aliphatic, polyether, polycarbonate, or caprolactone urethane, with or without copolymers
water-born or solvent-born isocyanate copolymer
water-born or solvent-born chloroprene or chloroprene coelastomer
water-born or solvent-born epoxide or epoxide copolymer
water-born melamine or melamine copolymers
water-born urea or urea copolymer

### Primer Surface

The invention includes the need for a functionalized surface that offers good candidate bond sites for the chromophores. Pendent hydroxyl, hydrogen, or nitrile groups are included in various embodiments. In embodiments, the effective total surface energy of the primed fiber exceeds 30 mJ/m2 and in some embodiments it exceed 45 mJ/m2.

### Primer Example I

As an example, in one embodiment a primer is used that contains Rhoplex HA-16 acrylic resin with BayHydrol UH240, which is a co-polymer acrylic urethane emulsion designed for coating Para-aramid fiber. In this example 40% of the solids are polyurethane (PU) and 60% are acrylic. The liquor includes 1% of a water-soluble isocyanate on the urethane mass for urethane cross linkage. In some other embodiments the primer mix has a low solids content that is between 5-10%, with a resultant Brookfield viscosity between 50 and 300 cps. In various embodiments the solids content and viscosity are tailored to achieve good fiber wet-out and optimal coating pickup. In this example, the coating pickup is between 1% and 2% dry pickup.

After the primer is applied to the fiber, it is dried at a temperature of between 150 and 200° F. to remove excess water prior to curing. Once dried, the primer is cured and crosslinked to the fiber at a temperature of 350° F. The primed fabric is then colored using a substantive dye of the direct type. The concentration of the substantive dye can be adjusted and tailored to the targeted finished color. In this example the dye is applied at an elevated temperature of between 150 and 180° F. in order to achieve sufficient dye association with the primed fabric. In this step, the typical dye pickup is less than 2% for a suitable color saturation. The resultant colored material is then dried at a temperature of between 160 and 200° F. to set the final color. The dye may be fix and soap finished according to normal processing.

### Primer Example II

Another example is a primer containing a copolymer acrylic melamine emulsion. In this example, the acrylic melamine emulsion contains Rhoplex HA-16 acrylic resin, 5% Aerotex M3 resin, and 2% Urea, with between 0.1% and 0.2% Aerosol OT in a surfactant solution. This primer also has a low solids content of between 5% and 10%, with a Brookfield viscosity below 300 cp. In this example, the coating pickup is less than 1.0% dry pickup, which maintains the fabric hand.

Once the primer is applied to the fiber, it is dried at a temperature of between 150 and 200° F. to remove excess water prior to curing. The primer is then cured and crosslinked on the fiber at a temperature of 350° F. The primed fabric is then colored using a standard commercial pigment dyestuff and binder system. The concentration of the pigment dyestuff can be adjusted and tailored to the targeted finished color. This pigment dyestuff and binder is applied following commercial exhaust pigment dyeing procedures in order to achieve sufficient pigment attachment to the primed fabric. In this step, typical pigment pickup is between 1% and 5% for a suitable color saturation. The resultant colored material is then dried at a temperature of between 160 and 200° F. to set the final color.

### Scour PreProcess

In embodiments, the fabric is scoured and pre-processed so that the base fiber is as nearly free of spin finish and size as possible. In various embodiments, a Soxhlets Extraction in a relevant solvent has less than 0.5% extractable oils and waxy material, and in some of these embodiments less than 0.2%. In embodiments, the primer attachment step and the scouring step are both preformed at low or no fabric tension. For the scouring step, this permits full access to the fabric yarns for the scour liquor and rinse water.

### Primer Application Process

In embodiments, the protective textile is exposed to long contact times with the primer liquor, which results in good saturation of the textile. In this regard, the invention differs from conventional coating practice. The polymers used in the primer are all typical coatings and adhesives used in blade and roll coating processes. However, according to the present invention the primer coatings are applied such that the textile has significant contact time with the primer liquor while not under tension. This low-tension, long-contact time is typical of dyeing processes, but is novel for application of primers and coatings. According to the present invention, this long-exposure primer application process results in the creation of a level and well penetrated primer layer on the textile fibers. Because the pigments from the dyes attach to the primer surface, the overall evenness of the coloration process is directly related to the consistency of the primer layer. Accordingly, embodiments include equipment drum dyeing, dye beck dyeing, or jet dyeing. Unlike traditional dyeing processes, there is no requirement for high pressures in the primer application process of the present invention, although application of pressure during primer application is also within the scope of the invention.

In embodiments, the viscosity of the primer liquor is kept under 750 cps, and in some embodiments it is kept under 300 cps. Low viscosity primer coating liquor provides good contact with the fiber in embodiments that are applicable to tighter, higher cover textiles that have smaller void volumes.

### Drying Step

In embodiments, the uncured primer is fragile before the water and or solvent has been driven off. Tumble drying in such embodiments is avoided, and some embodiments use open-width hot air oven drying to avoid marking or damage to the uncured primer layer.

### Selection of the Coloration Step

The dyeability of a primed textile of the present invention is dependent on the affinity of the dye or pigment dye system to the primer surface. The selection of the chromophores is therefore based on compatibility with the primer, not on compatibility with the base fiber. In various embodiments, direct dye, acid dye, disperse dye, and/or basic dye stuffs all play a role in combination with the primer systems. The present invention differs from conventional dyeing processes in that known dye chemistry can be applied to high-tenacity fibers by applying a coating of known performance, such as nylon, to the primer onto which the dyes can be attached. This offers a practical solution to the challenge of dye application to high-tenacity fibers.

### Coloration at High Luminosity

Para-aramid, LCP, and many other aromatic fibers are not white. They range from bright yellow to muddy tan in color. This presents a challenge for dyeing fabrics made using these fibers. Because the color starting point is yellow-tan, and not white, and using the L*a*b* scale these fibers have luminosity and a*b* values of:

Para Aramid (Yellow varieties)

L*85

a*0.05

b*25

Para Aramid (Tan varieties)

L*76

a*0.75

b*20

### Liquid Crystal Polyester

L*82

a*1

b*20

The result of these fiber base colors is a very high sensitivity to dye and pigment leveling issues, especially for light shades. The result of any incomplete or non-uniform primer or dye penetration can result in a yellow or tan cast to the finished materials. Accordingly, any shade (other than tans or yellows) that has a target Luminosity in the range of 65-75 represents a challenge for level dying. However, when properly applied, the present invention is capable of producing colors in the red, brown, green, blue, and grey shades with full cover and level color at L* values in the challenging light end of the range, namely 60-70.

In embodiments, level dying to high tenacity fibers having a Luminosity range of 65-75 can be achieved over a wide temperature range. Applying green, red, yellow or brown dyes on a primed para-aramid/LCP fabric presents considerable challenges due to the fabric's yellow-tan base color. According to the present invention, preparation of the fibers containing at least 20% high-tenacity fibers with an appropriate primer similar to those listed in the examples renders the fibers suitable for dyeing with commercial coloration systems. In embodiments, dye attach to the primed surface can be effected with dispersion dying over the temperature range of 140 to 180° F., similar to temperatures for primer application.

In other embodiments, level dyeing in the target Luminosity range of 65-75 is improved by using a bath temperature of 160° F. for brown and green pigments.

In further embodiments, level dyeing in the target Luminosity range of 65-75 is even further improved by using a bath temperature of 180° F. for brown, green, red and yellow dyes. Applying dye at this temperature is not a typical dye attachment approach for attaining level color coverage on high tenacity fibers with a base color of yellow-tan. By adding dye to the fabric at 180° F., the strike rate of the colors is increased sufficiently to provide level coloration.

As discussed previously, it is possible to add necessary pigments to the primer to enhance level color application and color fastness. In applying a base pigment on which to apply a dye, degree of attachment can be enhanced. It is also possible to add a second polymer, e. g., nylon, over the primer as another vehicle for enhancing the strike rate and color fastness of the pigment and dye. Addition of a known coating composition onto the primer surface makes it possible to use known dye chemistries with well understood parameters for level dye attachment.

In embodiments, applying an overcoat, e. g., nylon, to the primer prior to adding the pigment base and dye results in a better strike rate and an improved levelness to the color, as compared to fabric pigmented and dyed without the overcoat.

In other embodiments, applying a pigment-containing nylon overcoat to the primer improves the strike rate while maintaining a level color coating.

In further embodiments, adding pigment to the primer further enhanced the strike rate of the dye. A consistent color level can be achieved in embodiments by adding an overcoat such as nylon onto the pigmented primer.

The steps as discussed above are illustrated by the flow diagram presented in FIG. 4. First, the primer is applied, which in embodiments is an acrylate and/or urethane polymer 400. The textile is then gently dried 402, followed by a curing process 404. Substantive dye is then applied 406, followed by a fix and soap process 408.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A colorized yarn or textile comprising:
a yarn containing at least 20% protective fibers, or a textile constructed from yarns containing at least 20% protective fibers, where protective fibers are defined as fibers having a tenacity of at least 12 gpd;
a primer layer coating substantially all of the fibers, the primer layer being cross-linked sufficiently to render it insoluble under garment-washing conditions, the primer layer including molecular binding sites that are compatible for attachment of ink or dye molecules thereto; and
a coloration layer including at least one of a substantive dye and pigment, the coloration layer being attached to the primer layer by a polymeric binding layer.

2. The yarn or textile of claim 1, wherein the protective fibers are liquid crystal polymer fibers.

3. The yarn or textile of claim 1, wherein the protective fibers are para-aramid.

4. The yarn or textile of claim 1, wherein the protective fibers are liquid crystal polyester fibers.

5. The yarn or textile of claim 1, wherein the primer includes a polymer.

6. The yarn or textile of claim 1, wherein the primer includes an elastomer.

7. The yarn or textile of claim 1, wherein the primer includes a water-born or solvent-born acrylate or acrylate co-polymer.

8. The yarn or textile of claim 1, wherein the primer includes a water-born or solvent-born aliphatic, polyether, polycarbonate, or caprolactone urethane or a co-polymer thereof.

9. The yarn or textile of claim 1, wherein the primer includes a water-born or solvent-born isocyanate copolymer.

10. The yarn or textile of claim 1, wherein the primer includes a water-born or solvent-born chloroprene or chloroprene coelastomer.

11. The yarn or textile of claim 1, wherein the primer includes a water-born or solvent-born epoxide or epoxide copolymer.

12. The yarn or textile of claim 1, wherein the primer includes a water-born melamine or melamine copolymer.

13. The yarn or textile of claim 1, wherein the primer includes a water-born urea or urea copolymer.

14. The yarn or textile of claim 1, wherein the primer layer includes a water-born pigment.

15. The yarn or textile of claim 1, wherein the primer layer includes a solvent-born pigment.

16. The yarn or textile of claim 1, wherein substantially all of the fibers are protective fibers.

17. The yarn or textile of claim 1, wherein the primer layer has a surface energy of greater than 35 mJ/m2.

18. The yarn or textile of claim 1, wherein the molecular binding sites of the primer layer include hydroxyl sites.

19. The yarn or textile of claim 1, wherein the molecular binding sites of the primer layer include hydrogen bonding sites.

20. The yarn or textile of claim 1, wherein the molecular binding sites of the primer layer include nitrile sites.

21. The yarn or textile of claim 1, wherein the polymeric binding layer coats substantially all of the primer layer.

22. The yarn or textile of claim 1, wherein the polymeric binding layer includes an acrylate or a urethane.

23. The yarn or textile of claim 1, further comprising an antimicrobial layer coating the polymeric binding layer or substantive dye coating layer.

24. The yarn or textile of claim 1, wherein the substantive dye is direct, basic, cationic, or reactive.

25. The yarn or textile of claim 1, wherein the coloration layer includes an inorganic pigment.

26. A method for coloring a protective yarn or textile, the method comprising:
providing a protective yarn containing at least 20% protective fibers, or a protective textile constructed from yarns containing at least 20% protective fibers, where protective fibers are defined as fibers having a tenacity of at least 12 gpd;
applying a primer layer to the protective yarn or protective textile so that the primer layer coats substantially all of the fibers, the primer layer including molecular binding sites that are compatible for attachment of ink or dye molecules thereto;
drying the protective yarn or textile so as to remove any excess water or solvent;
heating the protective yarn or textile to a temperature sufficient to cause the primer layer to cross-link sufficiently to render it insoluble under garment-washing conditions; and
applying a substantive dye or pigment to the primer layer, so that the dye or pigment is attached to the molecular binding sites of the primer layer by a polymeric binding layer.

27. The method of claim 26, wherein the primer layer is applied in a dye beck, dye jig, piece dye, or jet dye apparatus.

28. The method of claim 26, wherein the protective yarn or textile is under substantially zero tension during application of the primer layer.

29. The method of claim 26, wherein substantially all of the fibers are protective fibers.

30. The method of claim 26, wherein the primer layer has a surface energy of greater than 35 mJ/m2.

31. The method of claim 26, further comprising coating substantially all of the primer layer with a pigment-binding layer or substantive dye coating layer.

32. The method of claim 31, wherein the pigment-binding layer includes an acrylate or a urethane.

33. The method of claim 31, further comprising coating the pigment-binding layer or substantive dye coating layer with an antimicrobial layer.

34. The method of claim 31, wherein the primer includes a water-born or solvent-born acrylate or acrylate co-polymer.

35. The method of claim 31, wherein the primer includes a water-born or solvent-born aliphatic, polyether, polycarbonate, or caprolactone urethane or a co-polymer thereof.

36. The method of claim 31, wherein the primer includes a water-born or solvent-born isocyanate copolymer.

37. The method of claim 26, wherein the primer includes a water-born or solvent-born chloroprene or chloroprene coelastomer.

38. The method of claim 26, wherein the primer includes a water-born or solvent-born epoxide or epoxide copolymer.

39. The method of claim 26, wherein the primer includes a water-born melamine or melamine copolymer.

40. The method of claim 26, wherein the primer includes a water-born urea or urea copolymer.
